(19) United States
(12) Patent Application Publication
(10) Pub. No.: US 2013/0105532 A1
(43) Pub. Date: May 2, 2013

(54) Portable Golf Car Accessory Organizer

(71) Applicant: Vance A. Lorenzana, Oswego, IL (US)

(72) Inventor: Vance A. Lorenzana, Oswego, IL (US)

(21) Appl. No.: 13/287,010

(22) Filed: Nov. 1, 2011

(51) Int. Cl. B60R 9/00

(52) U.S. Cl. 224/274

(57) ABSTRACT

An accessory organizing device for a golf car having a longitudinal member, a mounting bracket for mounting the device to the vertical support bars of a golf car, and accessory holders which engages with the longitudinal member. The longitudinal member has grooves or slots along at least a portion of the length of the longitudinal member. Accessory holders are supported by the longitudinal member by engagement with the grooves. The accessory holders are removeably or adjustably engaged with the grooves. Accessory holders and be adjustable in position and orientation along the longitudinal member to suit the user's needs. Accessory holders can be specific for a particular device such as a phone or a GPS device, or be a general receptacle such as a pouch or a tray for holding various accessories as desired by the

### FIELD OF THE INVENTION

This invention relates to the field of accessory organizing devices for use with a golf car, and in particular accessory organizers which are removable and portable.

### BACKGROUND OF THE INVENTION

A golfer often carries accessories when on the golf course. To allow for ease of playing, accessories are often left on the golf car. The accumulation of accessories in a golf car can lead to disorganization. Due to the small size of the golf car, it may be difficult to arrange items as desired. Furthermore, due to the short term rental nature of a golf car, a user cannot permanently place organizational devices customized for the user's convenience in the golf car.

Current organizational devices are difficult to mount, and may be large, bulky or heavy. Some require mounting to the roof of the golf cat or higher up on the golf cart which would require the golfer to reach up. Other devices are permanently or semi-permanently installed.

The present inventor has recognized the need for an efficient system of organizing accessories.

The present inventor has recognized the need for an accessories organization system which is easily configured and mounted. The present inventor recognized the need for an accessories organization system that is easily disconnected from the cart and is sized to be easily transportable by a golfer to and from the cart. The present inventors recognized the need for an accessories organization system that does not interfere or bother a fellow golf car rider.

The present inventor has recognized the need for a portable accessories organization device which can be adapted to many different type of golf cars.

### SUMMARY OF THE INVENTION

An accessory organizing device for a golf car which comprises a longitudinal member, a mounting bracket for mounting the device to the vertical support bars of a golf car, and accessory holders which engages with the longitudinal member. The longitudinal member has grooves or slots along at least a portion of the length of the longitudinal member. Accessory holders are supported by the longitudinal member by engagement with the grooves. The accessory holders are removeably or adjustably engaged with the grooves. Accessory holders and be adjustable in position and orientation along the longitudinal member to suit the user's needs. Accessory holders can be specific for a particular device such as a phone or a GPS device, or be a general receptacle such as a pouch or a tray for holding various accessories as desired by the user.

Numerous other advantages and features of the present invention will be become readily apparent from the following detailed description of the invention and the embodiments thereof, from the claims and from the accompanying drawings.

### BRIEF DESCRIPTION OF THE DRAWINGS

FIG. 1 illustrates one exemplary embodiment of the accessory device mounted on the supports of the golf car.

FIG. 2 is a perspective view of the accessory device with accessory holders.

FIG. 3 is a perspective view of the mounting mechanism of the accessory device.

FIG. 3A is a perspective view of an alternate embodiment of a mounting mechanism,

FIG. 4 is a perspective view of one embodiment of the longitudinal member.

FIG. 5 is a perspective view of an accessory holder in engagement with the longitudinal member.

FIG. 6 is a perspective view of an alternate embodiment of the mounting mechanism.

FIG. 7 is a top view of the embodiment of FIG. 6.

FIG. 8 is a view along line 8-8′ of FIG. 7.

FIG. 9 is a view along line 9-9′ of FIG. 7.

FIG. 10 is an exploded view of the alternate embodiment of the mounting mechanism of FIG. 6.

FIG. 11 is a top view of the mounting mechanism of FIG. 6 connected to a vertical support bar.

### DETAILED DESCRIPTION

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

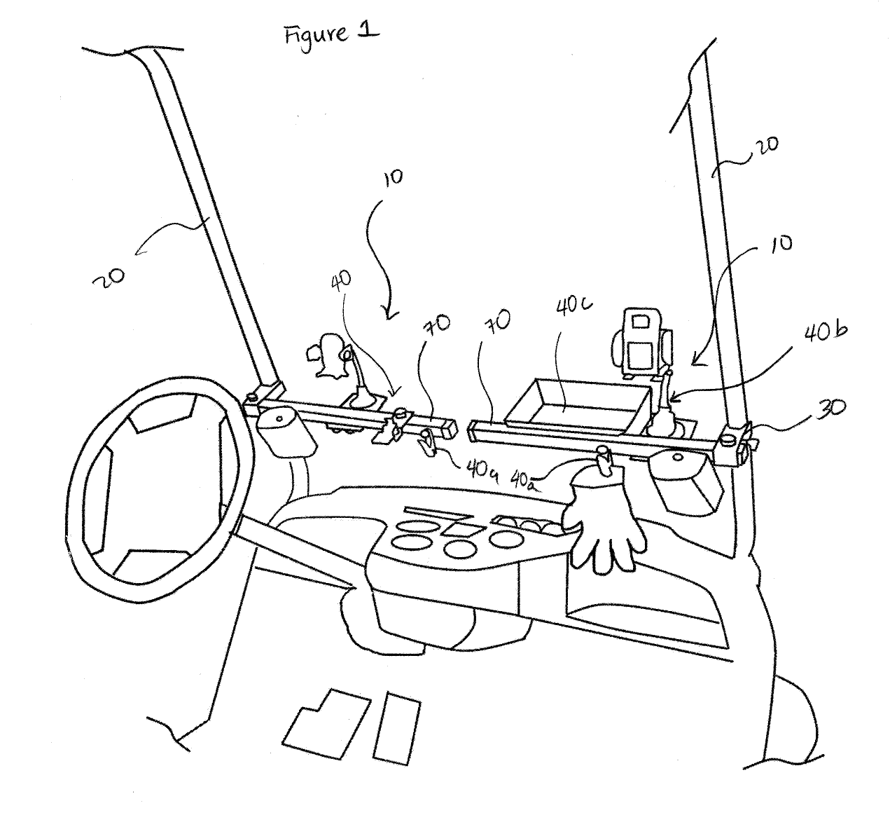

FIG. 1 illustrates the accessory organizing device 10 being used on both the driver's side and passenger side of the golf car, also known as a golf cart. The accessory organizing device 10 comprises a longitudinal member 70 onto which accessory holders 40 are remnovablely attached. The accessory organizing device 10 is mounted to vertical support bars 20 of the golf car through the use of a mounting bracket 30. The mounting bracket 30 has a longitudinal member support portion 50, and a vertical support bar 20 mounting portion 60.

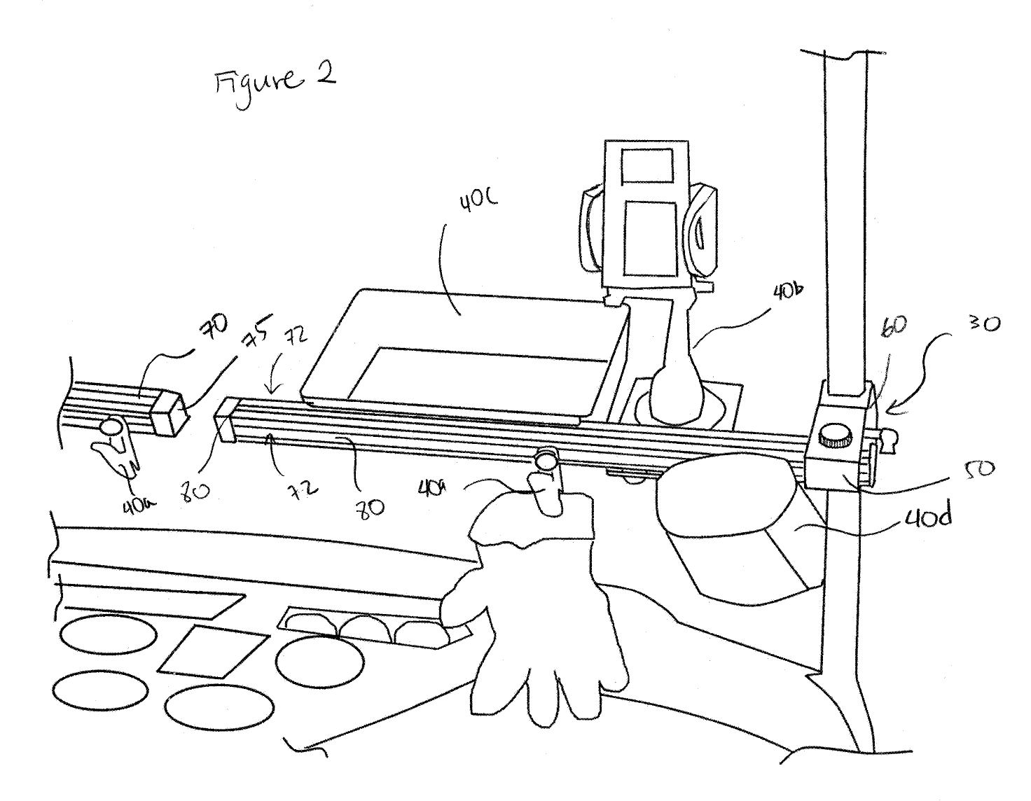

FIG. 2 illustrates one embodiment of a longitudinal member 70. Longitudinal member 70 has a rectangular cross section 75, which as illustrated in FIG. 2 is a square. The cross sectional area is not limited to a four sided regular polygon, and can be any suitable shape. The cross sectional area may have greater or fewer than four sides depending on the number of engagement surfaces desired. A greater number of sides will allow for more surfaces to engage with the accessory holders.

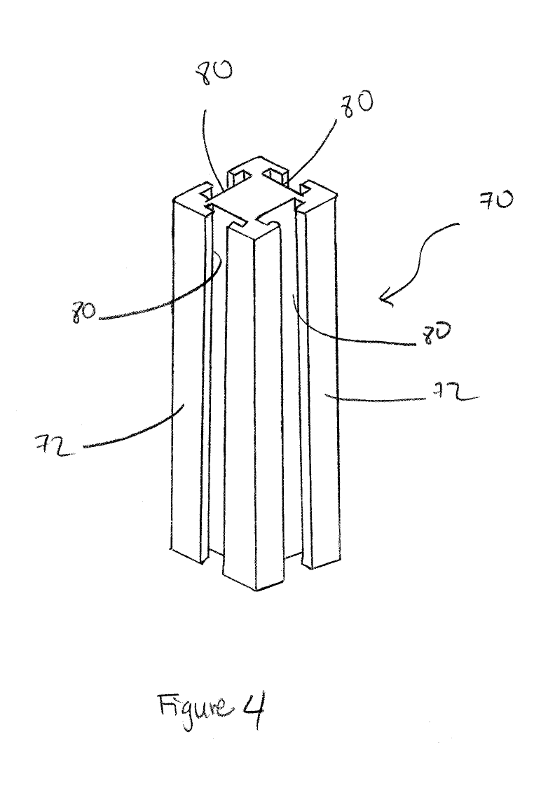

Each side 72 of the longitudinal member 70 has at least one groove 80 or slot along the length of the longitudinal member (FIG. 4). The longitudinal member may have a T-slot groove as illustrated in FIG. 4, or the longitudinal member may have a cross sectional area of a different shape, such as a trapezoidal shape. In one embodiment, the longitudinal member is the Bar or rail disclosed in U.S. Patent Application Publication 200210122691 or U.S. Pat. No. 5,429,438, each herein incorporated by reference to the extent not inconsistent with the present description. The longitudinal member can also have more than one groove or slot extending along the length of the longitudinal member on a side of the member.

In one embodiment, the longitudinal member 70 is of a length which extends for a portion of the width of the golf car, such as half the width, or a distance which spans one passenger seating area such as the driver or passenger seating areas, or a length which spans a portion of the length of the driver or passenger seating area. In use, each user, such as the driver and the passenger, brings their portable accessory organizing device to be mounted to their respective driver and passenger side vertical supports. Each user can adjust the height of the device to suit the user's positioning needs. Each user's accessory organizing device can be custom configured to have an array of accessory holders customized to each user and custom positioned as desired by the user. Accessory holders can be provided for a variety of accessories.

FIG. 2 illustrates various accessory holders which can be used with the longitudinal member 70. Accessory holders can be clips 40a for holding gloves or other accessories such as hats, bags, or food items such as bags of chips. Accessory holders can be a platform 40b to mount a GPS or GPS bracket or a mobile device. The accessory holders may be specific to particular accessories, such as a sunglasses holder (not shown), or the accessory holders may be designed to hold general accessories such as a tray 40c, a pouch 40d for holding various items. The accessory holders are attached to the longitudinal member.

Due to the various types of accessory holders, the weight on the accessory holder and thus its connection with the groove on the longitudinal member may vary to distribute the weight of the holder and prevent the accessory holder from falling out or shaking during use. Various mechanisms for providing the desired weight, forces of the accessory holder in securing it to the longitudinal rail along the grooves can be used.

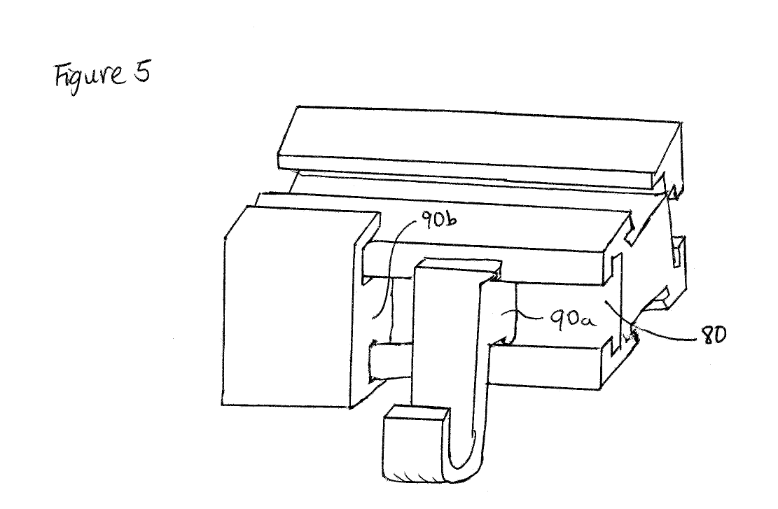

As illustrated in FIG. 5, each accessory holder has a groove engagement portion 90a, 90b which is inserted into the groove 80. Accessory holders such as a hook can have a segment which is inserted into the groove by sliding the engagement portion 90a in from the end of the longitudinal member. Other accessories may have a groove engagement component which can be snap fitted into the groove. Other accessory holders can have a groove engagement component and also a brace to on the outer surface to balance the force or weight of the accessory.

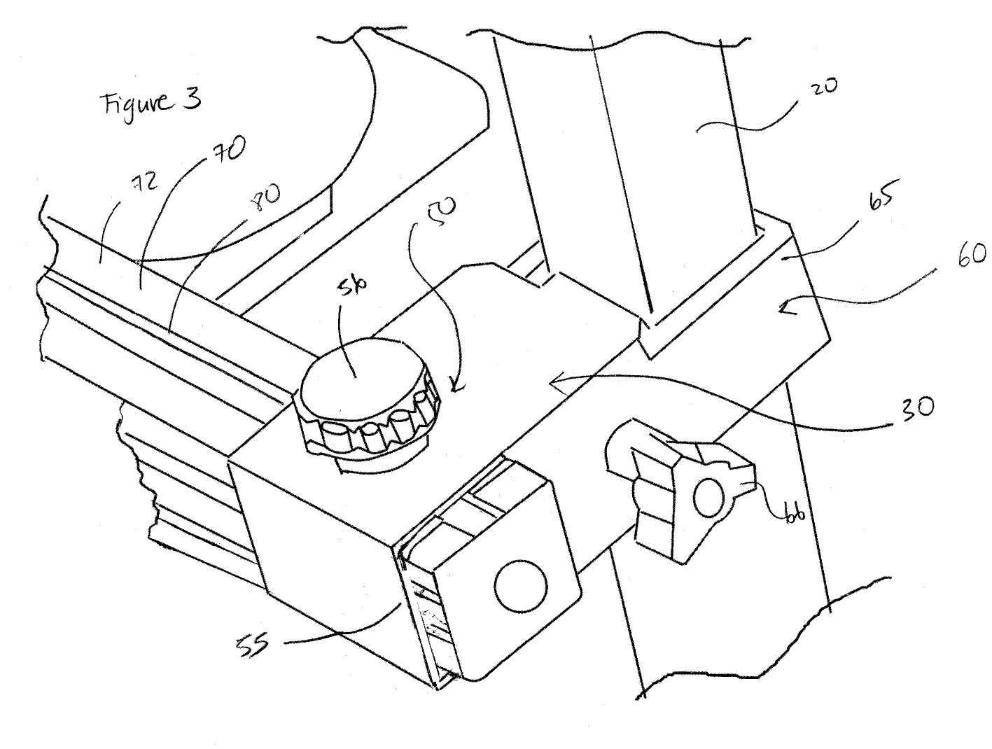

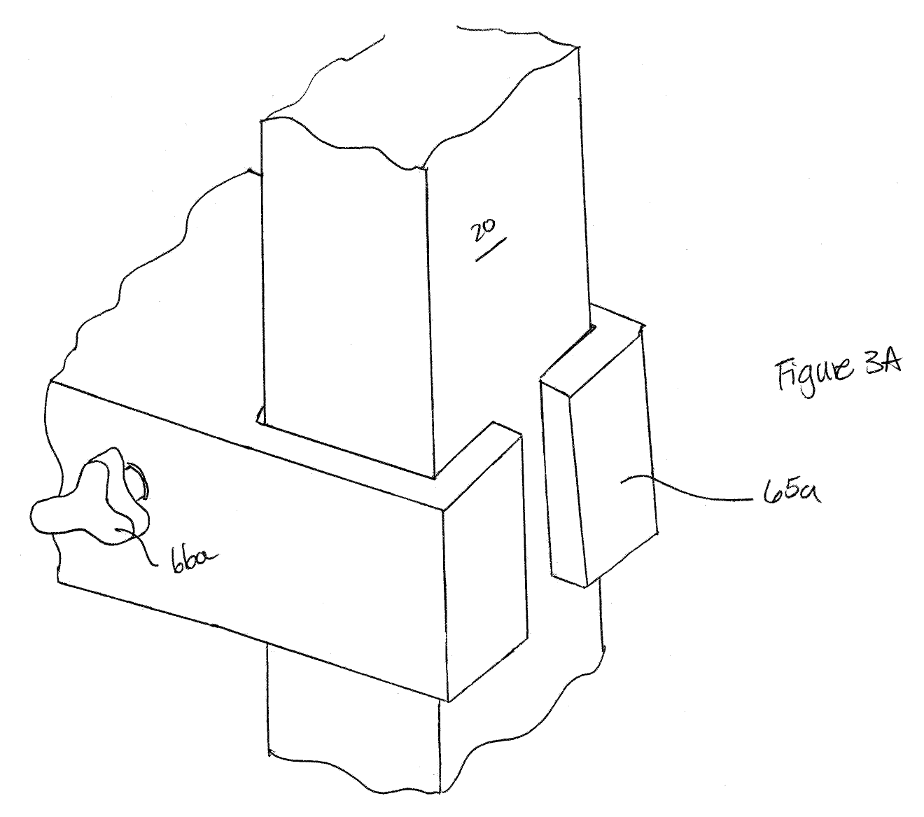

The accessory organizing device is mounted onto the support bars 20 of the golf car via a mounting bracket 30 illustrated in FIG. 3. The mounting bracket 30 has a longitudinal member supporting portion 50 and a vertical support bar mounting portion 60. The longitudinal member supporting portion 50 receives the longitudinal member 70 within a bracket 55 or shaft of a shape corresponding to the cross sectional shape of the longitudinal member 70. A tightening mechanism such as a fastening screw 56 is used to secure the longitudinal member 70 to the bracket 55 by, for example, creating pressure on to the longitudinal member. Bracket 55 can also be modified to receive longitudinal members of different cross sectional shapes. The bracket can be modified by use of additional fastening mechanisms to adapt the bracket for receiving longitudinal member of a different cross sectional shape. The longitudinal member 70 may be mounted to the bracket at a distal end of the longitudinal member as illustrated in FIG. 3.

To secure the longitudinal member 70 to the golf car, the bracket 50 holding the longitudinal member is secured to the vertical support bar 20 of the golf car by a securing mechanism on the vertical support bar mounting portion 60. The vertical support bar securing mechanism may be a U-Shaped brace 65 which corresponds to the cross sectional shape of a golf car support bar. The U-shaped brace may be detachably secured to the mounting bracket 30. The U-shaped brace is wrapped around the support bar and secured to the mounting bracket through the use of a fastening screw 66 by, for example, pressure force on to the U-shaped brace. The interior of the U-shaped brace 65 may be lined with material such a rubber to enhance the grip and connection of the U-shaped brace 65 with the vertical support bar 20 and allow for variations in the size of the golf car support bar 20. In one embodiment, instead of a U-shaped brace, the securing mechanism may be a C-shaped bracket 65a (FIG. 3A) which can be opened to receive the vertical support bar 20 of the golf car. The C-shaped bracket 65a may then be tightened about the vertical support bar 20 using a fastening mechanism such as a fastening screw 66a. Any other mechanism for connecting the longitudinal bar to a vertical support bar known to one skilled in the art may also be used.

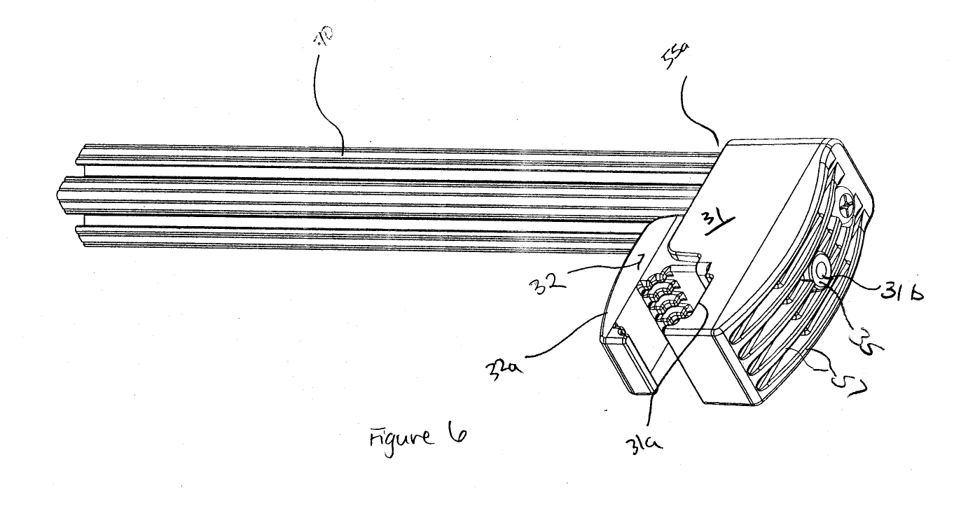

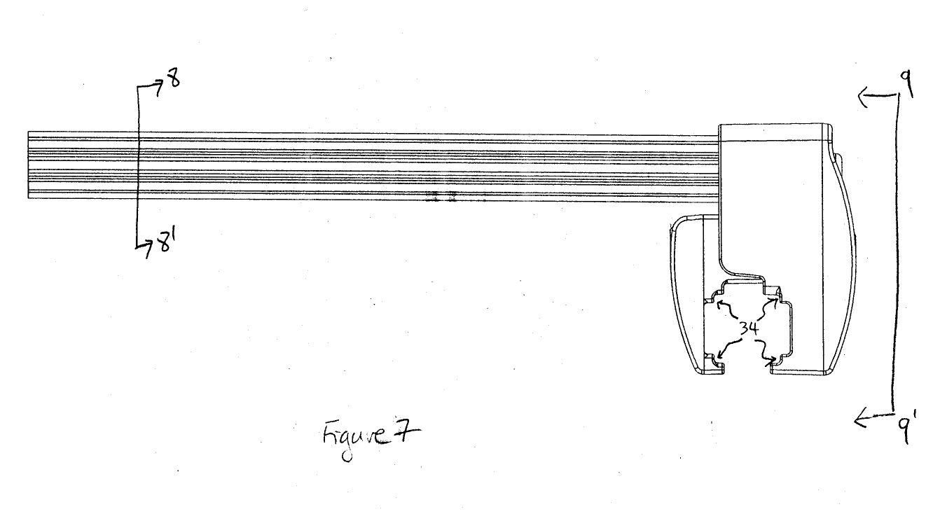

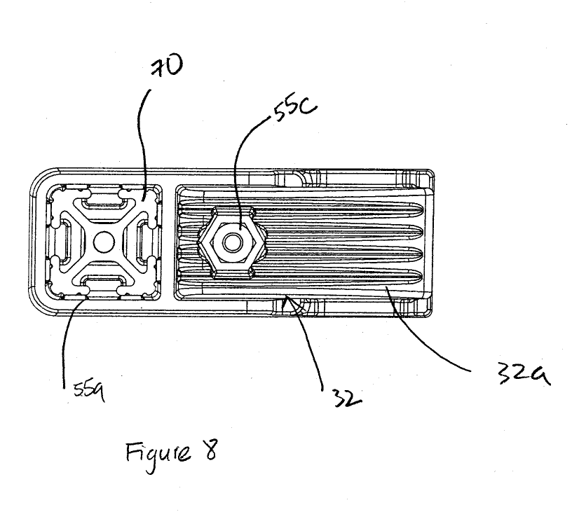

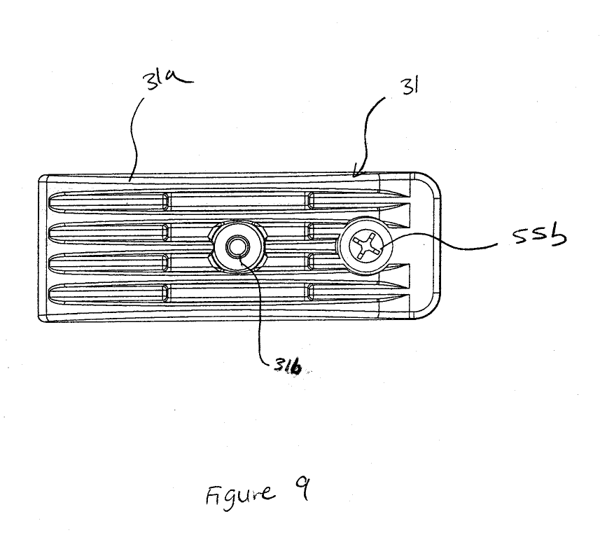

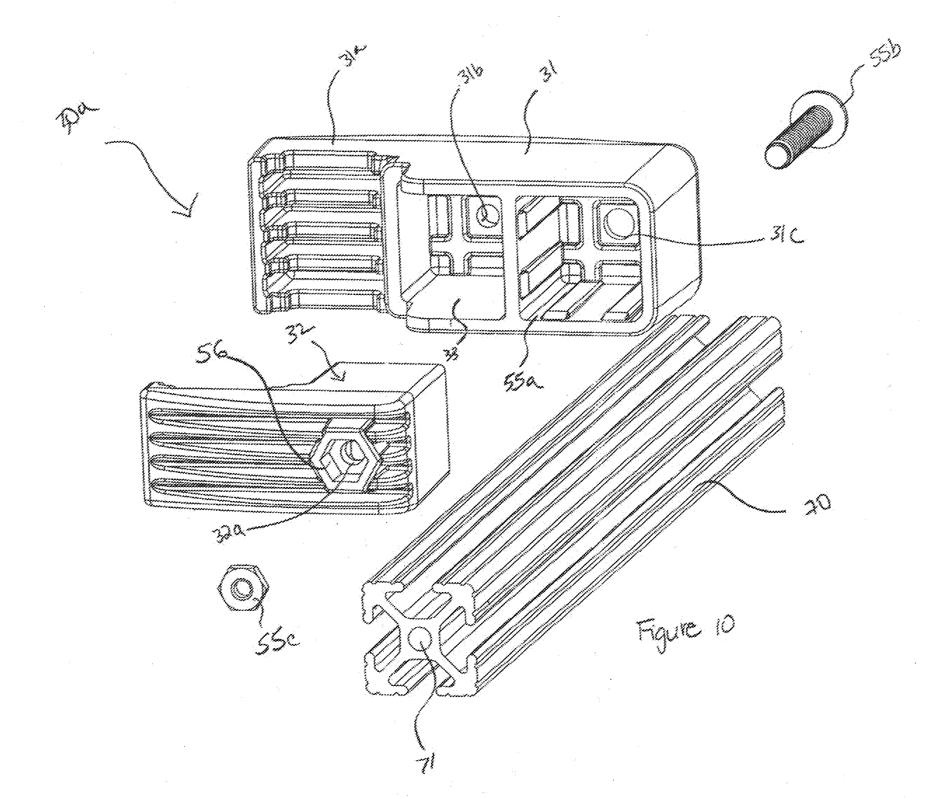

In another embodiment, the longitudinal member 70 is secured to a vertical support member 20 using a mounting bracket 30a as illustrated in FIG. 6. The mounting bracket has a stationary member 31 and a size adapting member 32, each having an arm 31a, 32a between which a region for engaging with a vertical support member 20 is formed. The stationary member 31 has a shaft 55a for receiving the longitudinal member. A distal end of the longitudinal member is fitted within the shaft, and secured to the shaft 55a by a fastening mechanism, such as a screw 55b, illustrated in FIG. 10 which fastens the longitudinal member to the stationary member through aperture 31c. One or more ends of the longitudinal member may have a threaded opening 71 for receiving the screw 55b. The stationary member 31 further comprises a receiving shaft 33 for receiving the size adapting member 32. The depth of the receiving shaft 33 for the size adapting member is of sufficient depth to allow the distance between the arms 31a and 32a to vary. A user adjusts the distance between the arms 31a and 32a by using a fastening mechanism, such as a screw or bolt (not shown) that extends through the aperture 31b in the top of the stationary member and through the adapting aperture 32b in the bottom of the adapting member 32 and connects with a nut 55c (FIG. 6), which is secured against rotation in recess 56 in the bottom of the adapting member 23. The top of the stationary member may have ridges 57. The ridges may be interrupted by a screw head platform 35 about the aperture 31b that may be recessed below the tops of the ridges 57 FIG. 8 illustrates the view along line 8-8′ of FIG. 7, and FIG. 9 illustrates the view along line 9-9′ of FIG. 7.

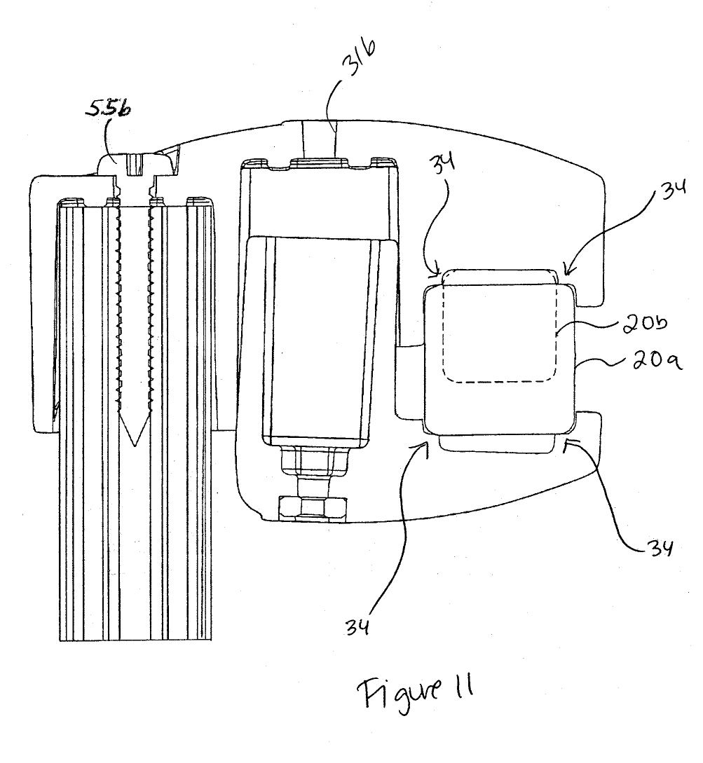

The arms 31a and 32a of the stationary member 31 and the size adapting member 32 comprise size adapting corners 34 (FIGS. 7 and 11). The size adapting corners allows for the arms 31a and 32a to adapt to vertical supports 20 of various areas. As illustrated in FIG. 11, the size adapting corners 34 allow for the arms 31a, 32a to adapt to vertical supports 20a having the large cross section (shown in solid lines) and to vertical supports 20b having a smaller cross section (shown in dashed lines). The size adapting corners 34 maybe to designed to suit vertical supports of various sizes, such as those formed by 1 inch (2.5 cm) tubing, or by inch (1.875 cm) tubing.

In one embodiment, the receiving shaft 33 for the size adapting member is sized to allow for movement of the size adapting member 32 within the shaft 33. As illustrated in FIG. 11, the size adapting member 32 is able to tilt within the shaft 33 within a range to better accommodate connection with various vertical supports. The range extends a predefined number of degrees from vertical alignment with the aperture 31b.

From the foregoing, it will be observed that numerous variations and modifications may be effected without departing from the spirit and scope of the invention. It is to be understood that no limitation with respect to the specific apparatus illustrated herein is intended or should be inferred.

The invention claimed is:

1. A portable accessory organizing device for mounting to a vertical support member of a golf car, comprising:
a longitudinal member having a grooved surface with at least one groove extending in a longitudinal direction;
a mounting bracket for mounting the longitudinal member to the vertical support member;
at least one accessory holder which removeably engages with the groove on the longitudinal member.

2. The device of claim 1 wherein the longitudinal member has a plurality of side surfaces, each surface having at least one groove.

3. The device of claim 1 wherein the groove is a T-shaped groove.

4. The device of claim 1 wherein the accessory holder adjustably engages with the groove.

5. The device of claim 1 wherein the accessory holder has a portion for engagement with the groove.

6. The device of claim 1 wherein the mounting bracket has a longitudinal member supporting portion and a vertical support bar mounting portion.

7. The device of claim 6 wherein the longitudinal member has a cross sectional shape; and wherein the longitudinal member supporting portion comprises a bracket with the same shape as the cross sectional shape.

8. The device of claim 7 further comprising a fastening mechanism to secure the longitudinal member to the bracket.

9. The device of claim 6 wherein the vertical support bar mounting portion has a removeable portion.

10. The device of claim 6 wherein the vertical support bar mounting portion comprises a fastening mechanism for securing the mounting bracket to the vertical support bar.

11. The device of claim 1 comprising a plurality of accessory holders.

12. The device of claim 1 wherein the accessory holder is a tray.

13. The device of claim 1 wherein the accessory holder is a clip.

14. The device of claim 1 wherein the accessory holder is a mobile device holder.

15. The device of claim 1 wherein the longitudinal member has a length which is less than the width of an average golf car.

16. A method of organizing accessories on a golf car having vertical supports comprising:
providing a longitudinal member having at least one groove on one surface of the longitudinal member;
securing the longitudinal member to the vertical support of the golf car; and
engaging accessory holders with the groove.

17. The method of claim 16 wherein the step of securing the longitudinal member to the vertical support of the golf car comprises the steps of:
securing a mounting bracket to the vertical support of the golf car;
inserting a distal end of the longitudinal member into a longitudinal member support portion of the mounting bracket; and
tightening a fastening mechanism disposed on the longitudinal member support portion of the mounting bracket.
